(19) United States
(12) Patent Application Publication
(10) Pub. No.: US 2012/0256149 A1
(43) Pub. Date: Oct. 11, 2012

(54) Roll Up Gate System

(76) Inventor: Brent Sylvester, Thunder Bay (CA)

(21) Appl. No.: 13/513,367

(22) PCT Filed: Dec. 3, 2010
(86) PCT No.: PCT/CA2010/001902

§ 371 Date: Jun. 1, 2012

Related U.S. Application Data
(60) Provisional application No. 61/266,401, filed on Dec. 3, 2009.

(51) Int. Cl. E06B 11/04

(52) U.S. Cl. 256/73

(57) ABSTRACT

A gate system for use with a gate opening which spans between two opposing ends includes an elongate sheet of flexible mesh fencing material spanning in a longitudinal direction between a first end and a second end thereof and which is wound onto a shaft coupled to the first end of the sheet. A housing rotatably supports the shaft therein such that the sheet of flexible mesh fencing material is arranged to be dispensed through an elongate dispensing slot in the housing to span the gate opening. Connectors on the housing and on the second end of the fencing allow selective mounting to appropriate mounts at opposing ends of the gate opening which remain engaged when the first end of the fencing material is wound onto the shaft sufficiently that the remainder of the fencing material spans under a prescribed tension across the gate opening.

### FIELD OF THE INVENTION

The present invention relates to a gate system comprising mesh fencing material arranged to be rolled up into a housing in a stored position and arranged to span a gate opening in a working position.

### BACKGROUND

Typically gates in chain link fencing and the like require a swing radius or space for a cantilevered gate as typical gates in the prior art comprise various forms of panels and the like which are hinged or mounted on sliding supports.

In other applications of temporary fencing, it is sometimes desirable for mounting gates in mines, city alleyways, parking lots, and surrounding various temporary event areas. In many instances it is undesirable to make use of conventional temporary fencing panels as a complete fence system may not be required.

One type of temporary fencing is available by Geobrugg and is available under the trade name FenceBox. A fencing system is disclosed in which a full perimeter fence in the order of 160 feet for example, is supported on a single roll within a contained enclosure. The large volume of fencing is clearly intended to be used as a full perimeter fence and is not readily portable. For stability, the container housing the roll of fencing material includes a concrete base which requires a fork lift to position in temporary locations. Once the fencing is dispensed from the container, the fencing is typically fastened to fixed poles to remain fixed in place as a security fence which cannot be readily releasable as may be desired when spanning a temporary gate opening.

### SUMMARY OF THE INVENTION

According to one aspect of the invention there is provided a gate system for use with a gate opening which spans between two opposing ends, the system comprising:

an elongate sheet of flexible mesh fencing material spanning in a longitudinal direction between a first end and a second end thereof;

a shaft coupled to the first end of the sheet of flexible mesh fencing material so as to span generally perpendicularly to the longitudinal direction of the sheet such that the sheet of flexible mesh fencing material is arranged to be rolled onto the shaft; and

a housing rotatably supporting the shaft therein such that the shaft is rotatable about an upright longitudinal axis of the shaft relative to the housing;

the housing surrounding the shaft and being spaced radially outwardly from the shaft such that the housing is arranged to receive the sheet of flexible mesh fencing material therein when the sheet of flexible mesh fencing material is rolled onto the shaft;

the housing including an elongate slot formed therein extending substantially parallel to the shaft so as to be arranged to receive the sheet of flexible mesh fencing material therethrough whereby the sheet of flexible mesh fencing material is arranged to be dispensed from a stored position substantially fully wound onto the shaft within the housing to a working position at least partially unwound from the shaft and spanning the gate opening;

the housing being arranged to be mounted at one end of the gate opening in the working position; and

the second end of the sheet of flexible mesh material being arranged to be mounted at the other end of the gate opening so as to be readily releasable therefrom in the working position.

The gate system according to the present invention preferably includes 40 feet of high tensile mesh, contained in an 18 in×18 in compact gate closure unit. The gate uses a roll-a-way system that negates the need for either a swing radius or the space required for a cantilever gate solution. The mounting of the housing, either on a single point or a double point mount, is a matter of rolling the unit up to the mounting brackets and clicking it into place. Once secured, the mesh is pulled out of the container and clipped onto the latch mount. The gate is then stretched tight using a hand crank.

Some applications of the gate system include the following:

Mines. Mines are one of the main benefactors of the gate system according to the present invention. This unit's compact container allows easy access into confined enclosures and mounted using a unique rock wall mount.

Personal/Commercial. The gate system of the present invention is also an ideal solution for the narrow alleyways found in cities, commercial parking lots and indoor locations.

Various mounts can be used for mounting the housing to an upright supporting surface as described in the following:

Mine Wall Mount. This mount is a single point mounting system that allows for the problems in the irregularities of a rock face to be over come. This system allows the gate to self adjust according to the profile of the rock walls.

Mobile Mount. This mounting system will allow for the gate to be easily installed on a mobile unit (i.e. an emergency vehicle) in order to deploy a gate barrier on remote locations.

Post Mount/Wall Mount. This mount is the typical mount that would be used on a steel post or on a building for a more permanent installation typical for residential and commercial usages. Once the mount is installed, the housing can be easily attached and removed as required.

Unlike prior art fencing material supported on rolls, the gate system of the present invention does not have self contained ballast. Instead, the gate system uses a mounting system for securement to an upright supporting surface. This makes the gate system of the present invention highly portable. There is no need for heavy equipment to move or place the gate system, but rather one person can install and operate this gate system.

The housing is preferably arranged to be mounted at the respective end of the gate opening in the working position such that the housing is readily releasable therefrom.

There may be provided an upright mount arranged to be fastened to an upright supporting surface at one of the ends of the gate opening in which the housing and the upright mount include mating connectors arranged to support the housing on the upright mount such that the housing is readily releasable from the upright mount.

The upright mount may comprise a plurality of vertically spaced fastener apertures arranged to permit fastening of the upright mount to the upright supporting surface in which the fastener apertures are arranged to be substantially covered by the housing when the housing is mounted on the upright mount.

A central mounting member may be provided on the housing centrally located between opposing ends of the housing in which the central mounting member is arranged to be coupled to an upright supporting surface at one of the ends of the gate opening such that the housing is pivotal about a horizontal axis oriented generally perpendicularly to a plane of the gate opening.

An upright mount arranged to be mounted to an upright supporting surface at one of the ends of the gate opening may include a first mating connector arranged for connection to a second mating connector on the housing such that the housing is arranged to be selectively mounted onto the upright mount and such that the housing is readily removable from the upright mount. Preferably the first mating connector is arranged to be restricted from being released from the second mating connector by unauthorized persons from at least one side of the gate opening or when tension is applied to the flexbile mesh fencing material spanning the gate opening.

A plurality of wheels may be arranged to be supported at one end of the housing such that the housing is manually portable and is supported for rolling movement along the ground. The wheels may be arranged to be selectively mounted onto either one of two opposed ends of the housing.

Preferably a second upright mount is arranged to be mounted to an upright supporting surface at an opposing end of the gate opening from the housing and which also includes first mating connectors arranged for connection to respective second mating connectors on the second end of the flexible mesh fencing material. These first and second mating connectors are also preferably readily releasable from one another while being restricted from being released from one another when tension is applied to the flexible mesh fencing material spanning the gate opening.

In this instance, the first mating connectors may comprise a plurality of sockets formed therein and the second mating connectors may comprise hooks arranged to be received in respective ones of the sockets in interlocking engagement therewith. The hooks are preferably arranged to be retained in interlocking engagement within the respective sockets in the working position when tension is applied to the fencing material.

In some embodiments there is provided a manual crank handle mounted externally on the housing in operable connection with the shaft for manually rotating the shaft relative to the housing.

Alternatively, or in conjunction with the manual crank handle, the housing may also include a motor mounted within the housing in operable connection with the shaft to drive rotation of the shaft. The motor is preferably arranged to be remote actuated.

A torque sensor may be coupled to the motor which is arranged to measure a torque of the motor corresponding to tension of the flexible mesh fencing material spanning the gate opening. The torque sensor may be further arranged to shut-off the motor when the measured torque exceeds a prescribed torque limit.

When a manual crank handle is provided with the motor, the handle is preferably arranged to be selectively mounted externally on the housing so as to remain readily separable therefrom. A motor shut-off switch is preferably provided in this instance which is arranged to disconnect the motor in response to the manual crank handle being mounted on the housing.

A braking mechanism may also be operably connected to the shaft so as to selectively provide frictional resistance to rotation of the shaft.

In a further embodiment, the elongate slot in the housing comprises a first slot extending in a longitudinal direction parallel to the shaft so as to be arranged to receive the sheet of flexible mesh material therethrough in a first dispensing orientation. In addition a second slot extend in the longitudinal direction parallel to the shaft at a location diametrically opposite from the first slot so as to be arranged to receive the sheet of flexible mesh material therethrough in a second dispensing orientation.

The housing in this instance preferably includes a first set of second mating connectors diametrically opposite the first slot which are arranged to be coupled to the first mating connectors of the upright mount in the first dispensing orientation and a second set of the second mating connectors diametrically opposite the second slot which are arranged to be coupled to the first mating connectors of the upright mount in the second dispensing orientation.

When used in combination with an upright tunnel wall, the tunnel wall may include a recess formed therein which is arranged to receive the housing therein such that the housing is fully recessed within the recess in the tunnel wall.

When used in combination with a mobile unit, preferably the mobile unit includes an upright mount mounted on an upright supporting surface thereof such that the housing is arranged to be selectively coupled to the upright mount while remaining readily releasable from the upright mount as desired.

Various embodiments of the invention will now be described in conjunction with the accompanying drawings in which:

### BRIEF DESCRIPTION OF THE DRAWINGS

FIG. 1 is a perspective view of the gate system in which the fencing material is partially dispensed from the housing with both the housing and the second end of the fencing material shown released from respective mounts at opposing ends of the gate opening.

FIG. 2 is a perspective view of the wheel base supporting wheels at one end of the housing.

FIG. 3 is a schematic representation of the internal components of the housing.

FIG. 4 is a top plan view of one exemplary installation of the gate system in a mining tunnel.

FIG. 5 is an elevational view of a further exemplary use of the gate system on a mobile unit.

FIG. 6 is a top plan view of a second embodiment of the gate system in a first dispensing orientation.

FIG. 7 is a top plan view of the second embodiment of the gate system in a second dispensing orientation.

FIG. 8 is a schematic elevational view of the second embodiment of the gate system is a partially closed position spanning only partway across the gate opening as the fencing material is being wound onto the shaft of the housing.

In the drawings like characters of reference indicate corresponding parts in the different figures.

### DETAILED DESCRIPTION

Referring to the accompanying figures, there is illustrated a gate system generally indicated by reference numeral 10. The gate system 10 is particularly suited for use in temporarily spanning a gate opening between two opposing ends 12 defining the gate opening spanning in a vertical plane there between. The opposing ends 12 of the gate opening may comprise various forms of upright supporting surfaces including walls, posts and the like.

The gate system 10 generally comprises a portable housing 14 which stores therein rolled up fencing material 16. The fencing material 16 generally comprises an elongate sheet of flexible mesh material which is elongate in a longitudinal direction between opposing first and second ends. The mesh material comprises interconnected strands of material in a pattern similar to conventional chain link fencing.

The housing 14 is elongate in an upright orientation in use spanning a height corresponding approximately to a height of the sheet between opposing longitudinally extending edges thereof. The housing extends in a respective longitudinal direction between two end panels 18 at opposing ends thereof. Each of the end panels 18 is generally octagonal in shape such that the sides of the housing comprise eight side walls 20 interconnected in a generally octagonal cross section so as to span in the longitudinal direction between the two end panels 18. The side walls 20 surround a hollow enclosure of the housing arranged to receive the fencing material 16 therein in storage.

A shaft 22 is rotatably supported within the housing to extend in the longitudinal direction thereof between the two opposed end panels 18. Suitable bearings 24 at opposing ends of the shaft 22 support the shaft on the end panels respectively such that the shaft 22 is rotatable about a longitudinal axis thereof which is generally vertical in use.

The shaft 22 couples the first end of the fencing material 16 thereon such that the shaft is oriented generally perpendicularly to the longitudinal direction of the sheet and the sheet is suitably arranged to be rolled onto the shaft when the shaft is rotated about its respective longitudinal axis. The shaft is centered in the housing an the housing is spaced outwardly from the shaft and surrounding the shaft such that the sheet can be fully rolled onto and wound about the shaft in the housing when the sheet comprises approximately 40 feet of fencing material in the longitudinal direction between the opposing first and second ends thereof.

The housing 14 includes an elongate slot 26 in the front side of the housing which spans the full length of the housing in the longitudinal direction. The slot 26 accordingly spans the height of the sheet of fencing material so that the sheet of fencing material can be received there through. Accordingly, the fencing material is arranged to be dispensed from a stored position in which the fencing material is fully wound onto the shaft and stored within the housing to a working position in which the fencing material is at least partially dispensed from the housing by being unrolled from the shaft to span across the gate opening.

The housing 14 includes a center mounting bar 28 and two end mounting bars 30 supported on the rear side of the housing opposite the front side locating the slot 26 therein. The end mounting bars 30 are located adjacent the opposing ends of the housing and the center mounting bar 28 is centrally located there between. All three bars comprise a rigid member spanning perpendicularly to the longitudinal direction of the housing to extend laterally outward beyond opposing side edges of the rear side wall 20 supporting the mounting bars thereon such that the bars span in a lateral direction approximately a full width of the housing.

The end mounting bars 30 permit attachment of a wheeled base 32 onto either end of the housing such that the wheeled base can be readily removed therefrom and attached to the other end as may be desired. The wheeled base 32 generally comprises a frame arranged to span the end panel at one end of the housing which includes a pair of retainers 34 mounted at the rear side for selective coupling onto opposing ends of the respective end mounting bar 30. A pair of wheels are supported at laterally spaced positions on the front side at the opposing end of the frame from the retainers 34.

The retainers 34 are arranged to be coupled to the mounting bars in a manner which permits the housing to be tilted forwardly for rolling movement onto the pair of wheels 36 at the front side of the wheel base while the retainers 34 retain the rear end of the frame of the wheel base 32 secured against the bottom end of the housing. Handles 38 are mounted externally on the side walls of the housing which are arranged to be suitably grasped in the hand of a user so that the handles 38 together with the wheels permit the housing to be manually portable by functioning as a hand truck.

The center mounting bar 28 permits the housing to be selectively mounted onto a first upright mount 40 mounted at one end 12 of the gate opening. The upright mount 40 is arranged to be secured to various forms of upright supporting surfaces. More particularly, the upright mount 40 comprises a rear panel 42 locating fastener apertures therein permitting fasteners to be received there through for fastening the rear panel to the upright supporting surface at the end of the gate opening. The upright mount 40 further comprises two side flanges 44 supported at laterally opposed side edges of the rear panel 42 to extend outwardly therefrom at an inclination such that the two side flanges project forwardly from the rear panel with increasing distance from one another towards respective forward edges. The two side flanges 44 are arranged to receive the housing there between and serve to guide alignment of the housing with the rear panel 42 in a mounted position of the housing on the first upright mount 40.

Each of the two side flanges 44 comprised as an upper edge which is sloped upwardly and inwardly at a suitable elevation for sliding engagement of opposing ends of the center mounting bar 28 respectively thereon. A pair of retainers 46 are mounted at the inner ends of the upper edges of the two side flanges 44 respectively. Each of the two retainers comprises a hook member which extends forwardly and downwardly into overlapping engagement with the side flanges at the free end thereof so that the retainers may be hooked over top of the respective ends of the center mounting bar to retain the centre mounting bar fixed onto the inner ends of the upper edge of the two side flanges respectively.

The two retainers 46 are connected to a common horizontal pivot shaft extending perpendicularly to the plane of the gate opening between the base of the two retainers 46 such that the two retainers are fixed for pivotal movement together with one another and the pivot shaft spanning there between from a locked position extending over top of the ends of the center mounting bar to retain the center mounting bar on the side flanges 44 and a release position in which the retainers are pivoted upwardly to be spaced above the side flanges at the free ends thereof so that the center mounting bar can be slidably disengaged from the upper edges of the two side flanges 44.

The forward edge of the two retainers 46 include respective cam faces which are sloped downwardly and inwardly so that inward displacement of the ends of the center mounting bar in engagement with the leading edges of the retainers 46 cause the retainers to be automatically deflected upwardly from the locked position to a released position when coupling the housing onto the first upright mount. A suitable mechanism can permit the retainers 46 to be automatically deflected downwardly into the locked position once the center mounting bar reaches the inner ends of the upper edges of the two side flanges. A lock mechanism can be mounted on only one side of the first upright mount to retain both the retainers 46 in the locked position as may be desired.

The two retainers 46 of the upright mount thus comprise a first mating connector and the center mounting bar comprises a second mating connector arranged to be selectively engaged with one another in the mounted position of the housing such that the housing remains readily releasable from the upright mount. The hooked configuration of the first mating connector is arranged such that the first mating connector is restricted from being released from the second mating connector when tension is applied to the flexbile mesh fencing material spanning the gate opening which pulls the housing away from the upright mount 40 towards the opposing end of the gate opening.

Furthermore, by restricting access to the mechanism to unwind the fencing material and release the tension therefrom, the first mating connector is arranged to be restricted from being released from the second mating connector by unauthorized persons from one or both sides of the fencing material spanning the gate opening.

The central location of the center bar 28 and the symmetrical configuration of the two retainers 46 permits the housing to be readily inverted between two mounting positions which are flipped 180 degrees relative to one another about a central horizontal access the reversibility of the coupling of the housing onto the first upright mount allows accommodating differing mounting configurations while also permitting the user to select from which side of the gate in the working position access is restricted by unauthorized persons.

The central location of the center mounting bar 28 also permits levelling of the housing about an axis of the center mounting bar which is generally horizontal and perpendicular to the plane of the gate opening. The gate in the working position can thus be levelled relative to the gate opening to ensure even tension across the full height of the fencing material in the working position.

The gate system further comprises an end bar 48 at the second end of the fencing material in which the end bar 48 spans a full height of the fencing material between the opposing longitudinally extending edges thereof. The end bar 48 includes a plurality of vertically spaced apart retainer hooks 50 fixed thereon. In the illustrated embodiment a retainer hook 50 is provided at each of the opposed ends of the bar as well as at a central location there between. Each of the retainer hooks includes a first portion 52 extending in the longitudinal direction of the fencing material outwardly beyond the edge of the fencing material and a second portion 54 mounted at the free end of the first portion. The second portion 54 is perpendicular to the first portion and spans laterally outward in two opposing directions therefrom to outer ends which are arranged to be hooked into respective sockets 56 of a second upright mount 58.

The second upright mount 58 comprises a vertical member arranged to be fastened to a upright supporting surface at the second end 12 of the gate opening. Suitable fasteners for securing the second upright mount 58 to the upright surface at the second end of the gate opening may be hidden within a channel of the vertical member forming the second upright mount 58.

The sockets 56 are vertically spaced in the hollow channel member forming the second upright mount so as to be aligned with the retainer hooks 50 of the end bar. Each of the sockets is also T-shaped comprising a horizontal opening forming an upper portion of the socket and a vertical opening forming a lower portion of the socket extending downward from a central location of the upper portion. The upper portion is arranged to receive the second portion of the retainer hooks therein while the vertical lower portion of the socket is narrower to correspond to the width of the first portion of the hooks so that the second portion is retained on opposing sides of the lower portion of the socket when the first portions of hooks are slidably displaced downwardly into the lower portions of the sockets. Inner protrusions may be provided within the socket which serve to prevent upward sliding of the hooks 50 into released engagement from the sockets 56 when tension is applied to the fencing material of the gate.

In this instance, the sockets 56 in the second upright mount 58 comprise first mating connectors while the hooks on the end bar comprise second mating connectors arranged for mating engagement with the first mating connectors in the closed position of the gate system. By arranged the first and second mating connectors at the second upright mount to also be restricted from being released from one another when tension is applied to the flexible mesh fencing material spanning the gate opening, both ends of the fencing material are prevented from being released from their respective end of the gate opening by unauthorized persons by limiting access to a winding mechanism 60 which controls tension on the fencing material.

The winding mechanism 60 permits the fence material to be rolled up from the working position to the stored position within the housing and also permits tension to be applied to the fending material spanning the gate opening in the working position.

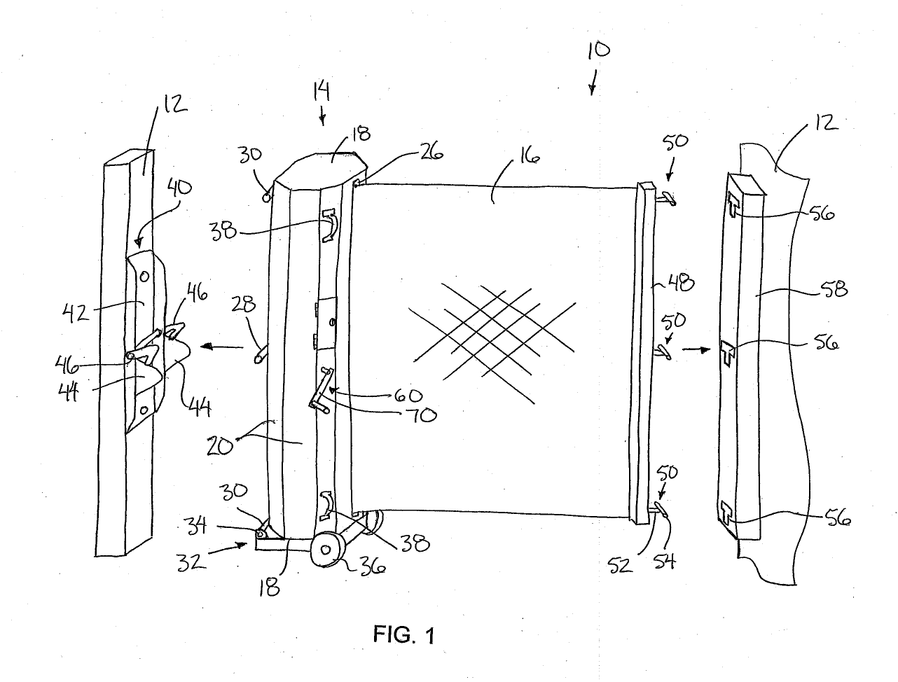

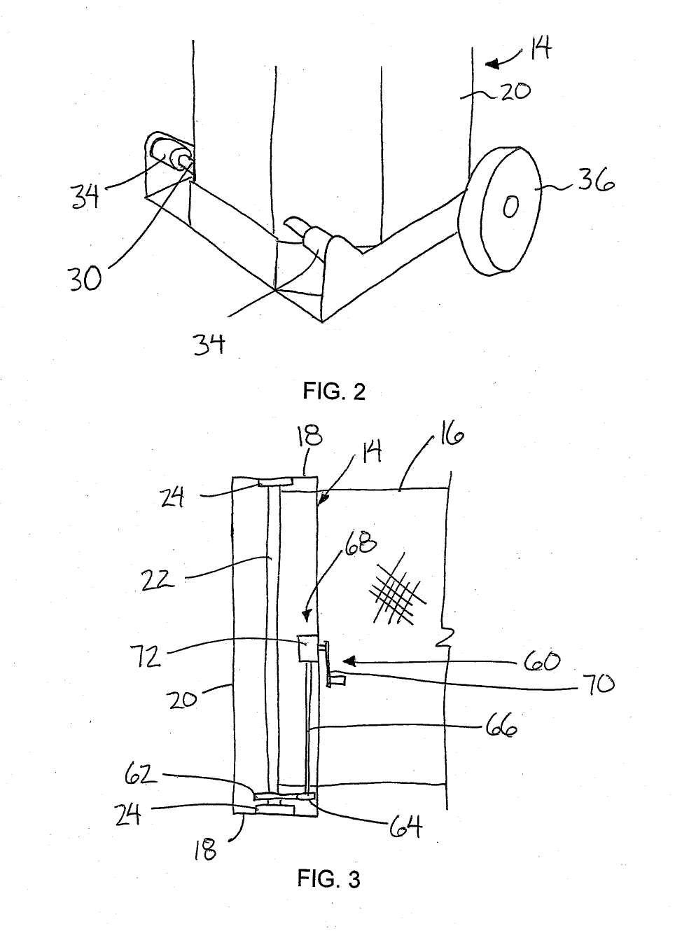

According to a first embodiment in FIGS. 1 through 3, the winding mechanism includes a driven gear 62 supported about the shaft adjacent one end thereof for meshing engagement with a drive gear 64 supported at the same end of the housing for rotation about a respective access which is parallel to and spaced outwardly from the shaft adjacent one of the side walls of the housing. A drive shaft 66 is coupled for rotation with the drive gear and extends in a longitudinal direction parallel to the shaft along an inner side of one of the side walls for connection to an actuator 68 at a central location on the housing between the opposing ends thereof. Rotation of the actuator causes rotation of the drive shaft 66 which in turn causes rotation of the primary shaft 22 supporting the fencing material thereon through connection between the driven gear 62 and the drive gear 64. In this embodiment a crank handle 70 is mounted externally on the housing for connection to the actuator 68 through a suitable internal gear box 72 in the housing manual rotation of the external crank handle 70 permits rotation of shaft 22 supporting the fencing material thereon in either direction for either rolling the fencing material onto the shaft or unrolling the fencing material from the shaft.

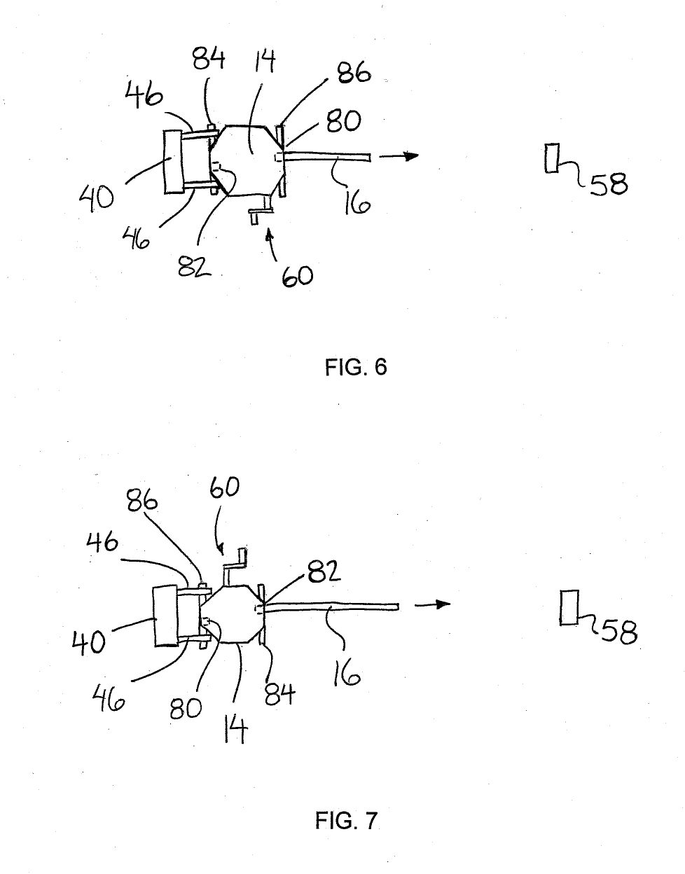

Turning now to the embodiment of FIGS. 6 through 8, the housing in this instance is substantially identical to the previous embodiment, but instead of inverting top and bottom ends of the housing to reposition the handle 60 relative to the dispensing slot in the housing, the housing according to FIGS. 6 through 8 is arranged to dispense the fencing material from either one of two diametrically opposed sides of the housing. Accordingly the housing in this instance includes a first dispensing slot 80 extending longitudinally along one side of the housing parallel to the shaft between the top and bottom ends of the housing, and a second dispensing slot 82 which is diametrically opposite to the first dispensing slot and which similarly extends in the longitudinal direction between the top and bottom ends, parallel to the shaft. The first dispensing slot dispenses the fencing material therethrough in a first dispensing orientation shown in FIG. 6 while the second dispensing slot dispenses the fencing material therethrough in a second dispensing orientation shown in FIG. 7.

The configuration of the retainers 46 forming the first mating connectors on the first upright mount 40 are similar to the previous embodiment for engaging second mating connectors on the housing. The housing in this instance however includes a first set of second mating connectors 84 diametrically opposite from the first slot 80 for mating with the first mating connectors 46 in the first dispensing orientation, and a second set of second mating connectors 86 diametrically opposite from the second slot 82 for mating with the first mating connectors 46 in the second dispensing position. In each instance, the first and second mating connectors are connected to remain engaged when tension is applied to the fencing material and to restrict release by unauthorised persons as described above with regard to the previous embodiment.

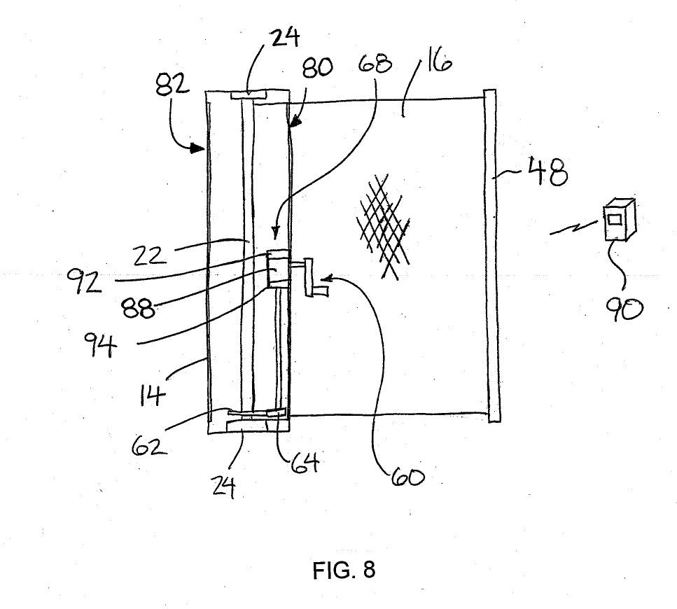

The embodiment of 6 through 8 also differs from the previous embodiment in that the actuator 68 comprises a suitable motor 88 which includes controls for operating the motor in a winding direction or operating the motor in either one of a winding or unwinding direction. The motor in the illustrated embodiment includes a remote controller 90 which is arranged to actuate operation of the motor in either the winding or unwinding directions. The remote controller 90 is suited for actuation by a user grasping the second end of the fencing material at a location spaced from the housing so that a single operator can support the fencing material in an upright orientation while operating the motor to displace the fencing material between working and stored positions as shown in FIG. 8.

The actuator 68 in this instance is also arranged to accept insertion of a handle 60 similar to the previous embodiment such that the manual crank handle is arranged to be selectively mounted externally on the housing in operable connection with the shaft for manually rotating the shaft relative to the housing, while also being readily separable from the housing when operating the motor. The actuator 68 also includes an appropriate motor shut-off switch 92 which is arranged to either electrically or mechanically disconnect the motor. The switch 92 is engaged by insertion of the manually operated handle 60 such that the switch is arranged to automatically disconnect the motor simply and automatically in response to engaging or mounting of the manual crank handle 60 onto the housing.

The motor 88 also includes a torque sensor 94 coupled thereto. The torque sensor 94 is arranged to measure a torque of the motor corresponding to tension of the flexible mesh fencing material spanning the gate opening. The torque sensor 94 is arranged to shut-off the motor when the measured torque exceeds a prescribed torque limit to ensure the fencing material is automatically tensioned to a desired level with causing damage to any components of the gate system.

The housing also comprises a suitable brake operating on the shaft which slows the unwinding of the shaft to maintain tension on the fencing material as the fencing material is drawn outwardly from the slot in the housing and is unwound from the shaft. The brake may also be operable using the remote controller 102.

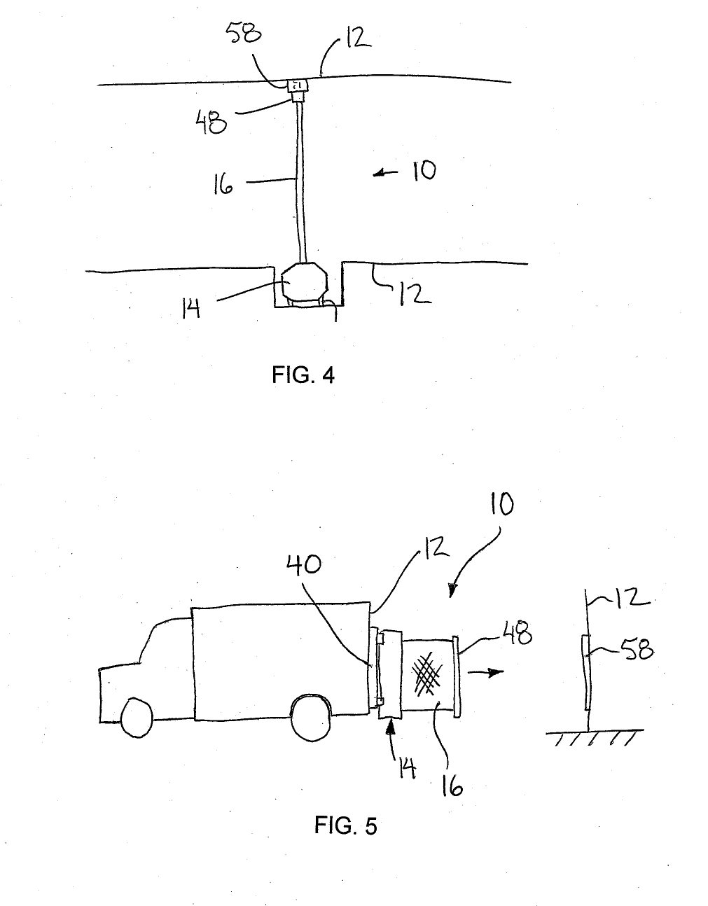

In use, the first upright mount can be located in various locations including upright walls in alley ways or upright walls along side a tunnel in mines and the like. In a mining application, suitable rock wall anchors may be provided as fasteners to fasten the first upright mount to the wall. As shown in FIG. 4, an alcove may be formed in the wall of a tunnel so that the housing may be fully recessed into the wall resulting in minimal obstruction in the tunnel when the fencing material is in the stored position. In yet further arrangements the first upright mount may be configured to anchor the two end mounting bars 30 instead of the centre mounting bar. Anchoring to the end mounting bars permits secure attachment to various structures including the upright supporting surface of a mobile unit such as a vehicle as shown in the embodiment of FIG. 5.

In a typical use of the gate system 10 both the first upright mount 40 and the second upright mount 58 are fastened to respective opposing ends 12 of a gate opening across which fencing material is desired to be temporarily mounted. The user then mounts the housing onto the first upright mount 40 such that the housing can be readily separated therefrom and reattached thereto without requiring any fasteners to be attached or removed. Once the housing is mounted in place on the first upright mount, the fencing material is dispensed from the housing towards the working position spanning the gate opening so that the hooks at the end bar at the second end of the fencing material can be interlocked with the sockets 56 of the second upright mount. Subsequent tension applied to the fencing material of the gate using the actuator 68 retains the hooks 50 within the respective sockets 56. The actuator 68 can be locked in a position which maintains some tension on the fencing material. Access to the actuator can be restricted through an access panel on the housing which can be locked in a closed position to prevent access by unauthorized persons.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A gate system for use with a gate opening which spans between two opposing ends, the system comprising:
an elongate sheet of flexible mesh fencing material spanning in a longitudinal direction between a first end and a second end thereof;
a shaft coupled to the first end of the sheet of flexible mesh fencing material so as to span generally perpendicularly to the longitudinal direction of the sheet such that the sheet of flexible mesh fencing material is arranged to be rolled onto the shaft; and
a housing rotatably supporting the shaft therein such that the shaft is rotatable about an upright longitudinal axis of the shaft relative to the housing;
the housing surrounding the shaft and being spaced radially outwardly from the shaft such that the housing is arranged to receive the sheet of flexible mesh fencing material therein when the sheet of flexible mesh fencing material is rolled onto the shaft;
the housing including an elongate slot formed therein extending substantially parallel to the shaft so as to be arranged to receive the sheet of flexible mesh fencing material therethrough whereby the sheet of flexible mesh fencing material is arranged to be dispensed from a stored position substantially fully wound onto the shaft within the housing to a working position at least partially unwound from the shaft and spanning the gate opening;
the housing being arranged to be mounted at one end of the gate opening in the working position; and
the second end of the sheet of flexible mesh material being arranged to be mounted at the other end of the gate opening so as to be readily releasable therefrom in the working position.

2. The gate system according to claim 1 wherein the housing is arranged to be mounted at the respective end of the gate opening in the working position such that the housing is readily releasable therefrom.

3. The device according to claim 1 wherein there is provided an upright mount arranged to be fastened to an upright supporting surface at one of the ends of the gate opening, the housing and the upright mount including mating connectors arranged to support the housing on the upright mount such that the housing is readily releasable from the upright mount.

4. The gate system according to claim 3 wherein the upright mount comprises a plurality of vertically spaced fastener apertures arranged to permit fastening of the upright mount to the upright supporting surface, the fastener apertures being arranged to be substantially covered by the housing when the housing is mounted on the upright mount.

5. The gate system according to claim 1 wherein there is provided a central mounting member on the housing centrally located between opposing ends of the housing, the central mounting member being arranged to be coupled to an upright supporting surface at one of the ends of the gate opening such that the housing is pivotal about a horizontal axis oriented generally perpendicularly to a plane of the gate opening.

6. The gate system according to claim 1 wherein there is provided an upright mount arranged to be mounted to an upright supporting surface at one of the ends of the gate opening, the upright mount including a first mating connector arranged for connection to a second mating connector on the housing such that the housing is arranged to be selectively mounted onto the upright mount and such that the housing is readily removable from the upright mount, the first mating connector being arranged to be restricted from being released from the second mating connector by unauthorized persons from at least one side of the gate opening.

7. The gate system according to claim 1 wherein there is provided an upright mount arranged to be mounted to an upright supporting surface at one of the ends of the gate opening, the upright mount including a first mating connector arranged for connection to a second mating connector on the housing such that the housing is arranged to be selectively mounted onto the upright mount and such that the housing is readily removable from the upright mount, the first mating connector being arranged to be restricted from being released from the second mating connector when tension is applied to the flexbile mesh fencing material spanning the gate opening.

8. The gate system according to claim 1 wherein there is provided a plurality of wheels arranged to be supported at one end of the housing such that the housing is manually portable and is supported for rolling movement along the ground.

9. The device according to claim 8 wherein the wheels are arranged to be selectively mounted onto either one of two opposed ends of the housing.

10. The gate system according to claim 1 wherein there is provided a mount arranged to be mounted to an upright supporting surface at one of the ends of the gate opening, the mount including a plurality of first mating connectors arranged for connection to respective second mating connectors on the second end of the flexible mesh fencing material such that the first and second mating connectors are readily releasable from one another, the first and second mating connectors being restricted from being released from one another when tension is applied to the flexible mesh fencing material spanning the gate opening.

11. The gate system according to claim 1 wherein there is provided a mount arranged to be mounted to an upright supporting surface at one of the ends of the gate opening, the mount including a plurality of first mating connectors arranged for connection to respective second mating connectors on the second end of the flexible mesh fencing material such that the first and second mating connectors are readily releasable from one another, the first mating connectors comprising a plurality of sockets formed therein and the second mating connectors comprising hooks arranged to be received in respective ones of the sockets in interlocking engagement therewith.

12. The gate system according to claim 11 wherein the hooks are arranged to be retained in interlocking engagement within the respective sockets in the working position when tension is applied to the fencing material.

13. The gate system according to claim 1 wherein there is provided a manual crank handle mounted externally on the housing in operable connection with the shaft for manually rotating the shaft relative to the housing.

14. The gate system according to claim 1 wherein there is provided a motor mounted within the housing in operable connection with the shaft to drive rotation of the shaft.

15. The gate system according to claim 14 wherein the motor is arranged to be remote actuated.

16. The gate system according to claim 14 wherein there is provided a torque sensor coupled to the motor, the torque sensor being arranged to measure a torque of the motor corresponding to tension of the flexible mesh fencing material spanning the gate opening, and the torque sensor being arranged to shut-off the motor when the measured torque exceeds a prescribed torque limit.

17. The gate system according to claim 14 wherein there is provided a manual crank handle arranged to be selectively mounted externally on the housing in operable connection with the shaft for manually rotating the shaft relative to the housing and a motor shut-off switch arranged to disconnect the motor in response to the manual crank handle being mounted on the housing.

18. The gate system according to claim 1 wherein there is provided a braking mechanism operably connected to the shaft so as to selectively provide frictional resistance to rotation of the shaft.

19. The gate system according to claim 1 wherein said elongate slot comprises a first slot extending in a longitudinal direction parallel to the shaft so as to be arranged to receive the sheet of flexible mesh material therethrough in a first dispensing orientation and wherein there is provided a second slot extending in the longitudinal direction parallel to the shaft at a location diametrically opposite from the first slot so as to be arranged to receive the sheet of flexible mesh material therethrough in a second dispensing orientation.

20. The gate system according to claim 1 wherein there is provided an upright mount arranged to be fastened to an upright supporting surface at one of the ends of the gate opening in which the upright mount includes first mating connectors, and wherein the housing includes a first set of second mating connectors diametrically opposite the first slot which are arranged to be coupled to the first mating connectors of the upright mount in the first dispensing orientation and a second set of the second mating connectors diametrically opposite the second slot which are arranged to be coupled to the first mating connectors of the upright mount in the second dispensing orientation.

21. The gate system according to claim 1 in combination with an upright tunnel wall, the tunnel wall including a recess formed therein arranged to receive the housing therein such that the housing is fully recessed within the recess in the tunnel wall.

22. The gate system according to claim 1 in combination with a mobile unit including an upright mount mounted on an upright supporting surface thereof, wherein the housing is arranged to be selectively coupled to the upright mount such that the housing is readily releasable from the upright mount.
